(19) United States
(12) Patent Application Publication
(10) Pub. No.: US 2018/0224160 A1
(43) Pub. Date: Aug. 9, 2018

(54) SPACEFRAME SUPPORT STRUCTURE FOR A SOLAR COLLECTOR

(71) Applicant: Sunvapor, Inc., Livermore, CA (US)

(72) Inventors: Nicolas Roberto PERALTA PEREZ, Walnut Creek, CA (US); Philip GLECKMAN, Livermore, CA (US); Justin RAADE, San Francisco, CA (US)

(73) Assignee: Sunvapor, Inc., Livermore, CA (US)

(21) Appl. No.: 15/892,105

(22) Filed: Feb. 8, 2018

Related U.S. Application Data
(60) Provisional application No. 62/456,588, filed on Feb. 8, 2017.
(60) Provisional application No. 62/546,518, filed on Aug. 16, 2017.

(51) Int. Cl. F24S 30/425; F24S 25/61; F24S 23/71; F24S 25/11

(52) U.S. Cl. CPC F24S 30/425; F24S 25/11; F24S 23/71; F24S 25/61

(57) ABSTRACT

A parabolic trough solar collector include a parabolic trough reflector extending in a longitudinal direction; and a frame supporting the reflector, the frame comprising at least one truss extending perpendicular to the longitudinal direction, the at least one truss comprising a plurality of wooden members connected at a plurality of joints, wherein: a first wooden member has a stiffness SWM1, a second wooden member has a stiffness SWM2, and a first joint that connects the first wooden member and the second wooden member together has a stiffness SJ1, and wherein: SWM1≤2×SJ1, and SWM2≤2×SJ1.

### CROSS-REFERENCE TO RELATED APPLICATIONS

This application claims priority to U.S. Provisional Application No. 62/456,588, filed Feb. 8, 2017, and U.S. Provisional Application No. 62/546,518, filed Aug. 16, 2017, which are hereby incorporated by reference in their entirety.

### STATEMENT REGARDING FEDERALLY SPONSORED RESEARCH OR DEVELOPMENT

This invention was made with Government support under U.S. Government contract DE-EE0007343 awarded by the U.S. Department of Energy. The Government has certain rights in this invention.

### FIELD OF THE INVENTION

The present invention relates to solar technologies, and more specifically, to parabolic trough solar collectors.

### BACKGROUND OF THE INVENTION

Support structures for supporting large optical devices such as telescopes and concentrating solar collectors are required to precisely maintain the original shape of the optical device that they support. Design of such structures leaves little room for structural deformation, material deterioration, and uncertainty. The Parabolic Trough Collector (PTC) is the most common single-axis concentrating collector architecture. The state-of-the art PTC has a total installed cost of about $200 per square meter, with 84% of the cost due to just the support structure and foundation. In order for the PTC to compete with photovoltaics in power generation, and with fossil fuel in process heating, a significant cost reduction is needed. The design of PTCs has not fundamentally changed in the last hundred years. A significant cost reduction requires a rethinking of the materials used for structural members and their joining.

### SUMMARY OF THE INVENTION

According to some embodiments, the cost of a PTC can be greatly reduced by using a wooden support structure configured to preserve the shape of the large, high-precision reflector of the PTC over time while using highly uncertain materials that may degrade over time. According to some embodiments, the support structure may include a plurality of trusses that extend perpendicularly to the longitudinal extent of the reflector of the PTC to resist splaying of the reflector caused by wind forces. The trusses may include an arrangement of wood members that interconnect at joints. The wood members and joints may be configured to satisfy a predefined relationship between member and joint stiffness that allow for minimal material and assembly cost while ensuring precision support for the reflector over time.

According to some embodiments, a parabolic trough solar collector includes a parabolic trough reflector extending in a longitudinal direction; and a frame supporting the reflector, the frame comprising at least one truss extending perpendicular to the longitudinal direction, the at least one truss comprising a plurality of wooden members connected at a plurality of joints, wherein: a first wooden member has a stiffness SWM1, a second wooden member has a stiffness SWM2, and a first joint that connects the first wooden member and the second wooden member together has a stiffness SJ1, and wherein: SWM1≤2×SJ1, and SWM2≤2×SJ1.

In any of these embodiments, a third wooden member and a fourth wooden member may be connected at the first joint, the third wooden member may have a stiffness SWM3, the fourth wooden member may have a stiffness SWM4, wherein: SWM3≤2×SJ1, and SWM4≤2×SJ1. In any of these embodiments, the first wooden member may extend from the first joint to a second joint that is adjacent to an outer portion of the reflector and the second joint may have a stiffness SJ2, wherein: SWM1≤2×SJ2. In any of these embodiments, a fifth wooden member may extend along the reflector to a third joint, the fifth wooden member may have a stiffness SWM5, and the third joint may have a stiffness SJ3, wherein: SWM5≤2×SJ3. In any of these embodiments, the second wooden member may extend from the third joint to the first joint, wherein: SWM2≤2×SJ3.

In any of these embodiments, the reflector may have an aperture width AW and a base of the at least one truss may have a width WB, wherein: WB≥½×AW. In any of these embodiments, the at least one truss may have a height TH that extends perpendicularly to the base from a bottom of the base to a top of a joint that is adjacent to the reflector, wherein: TH≥¼×AW.

In any of these embodiments, the third wooden member may extend to a joint that underlies a midpoint of the reflector. In any of these embodiments, the first joint may include at least one connector plate that joins ends of the first and second wooden members together. In any of these embodiments, the truss may include at least eleven wooden members and at least seven joints. In any of these embodiments, the truss may include at most eleven wooden members and at most seven joints.

In any of these embodiments, a first truss may be connected to a second truss by a torque-resisting wooden structure, and the torque-resisting wooden structure may connect a lower joint of the first truss to an upper joint of the second truss.

In any of these embodiments, the torque-resisting wooden structure may connect an upper joint of the first truss to a lower joint of the second truss. In any of these embodiments, the reflector may include at least one reflector panel and the at least one reflector panel may be mounted to at least one rafter that is parallel to the at least one truss.

In any of these embodiments, the rafter may be mounted on a purlin that extends between two trusses. In any of these embodiments, the frame may be rotatably mounted to support pylons so that the reflector can be rotated based on a position of the sun. In any of these embodiments, SJ1≥10 kN/mm. In any of these embodiments, an intercept factor of the collector may be at least 90% with a concentration ratio of at least 50.

### BRIEF DESCRIPTION OF THE DRAWINGS

The invention will now be described, by way of example only, with reference to the accompanying drawings, in which:

FIG. 1 is an isometric view of a parabolic trough collector from the concave side of the reflector, according to one embodiment;

FIG. 2 is an isometric view of the collector of FIG. 1 from the convex side of the reflector showing the spaceframe support for the reflector, according to one embodiment;

FIG. 3 is a truss portion of a spaceframe, according to one embodiment;

FIG. 4 is an isometric view of a spaceframe showing portions of the spaceframe that support the reflector, according to an embodiment;

FIG. 5 is a posterior view (i.e. from convex side) of the spaceframe, according to an embodiment.

FIG. 6 is an enlarged view of a base joint of the truss of FIG. 3, according to an embodiment;

FIG. 7 is an enlarged view of a center joint of the truss of FIG. 3, according to an embodiment;

FIG. 8 is an enlarged view of a top joint of the truss of FIG. 3, according to an embodiment;

FIG. 9 is an enlarged view of the attachment of torsion-resisting structures to a truss, according to one embodiment;

FIG. 10A illustrates the limits of the joint and member for defining joint and member stiffness, according to one embodiment;

FIG. 10B illustrates a test setup for measuring joint stiffness, according to one embodiment; and

FIG. 11 illustrates a parabolic trough collector from the concave side of the reflector, according to another embodiment.

### DETAILED DESCRIPTION OF EXEMPLARY EMBODIMENTS

Described below are exemplary parabolic trough collectors that include wooden support frames configured to preserve the shape of large, high-precision reflectors using highly uncertain but cost effective materials-lumber and lumber connectors. According to some embodiments, the structural topology of the spaceframe follows two key design parameters: (1) a fundamental relationship between member and joint stiffness, and (2) a minimum joint stiffness. These parameters combine to minimize the impact of uncertainties of joint mechanical behavior and deterioration over time, which can be significant factors in designing with lumber. According to some embodiments, the sensitivity of the overall performance of the spaceframe to joint stiffness is reduced by: (1) reducing the number of joints, (2) reducing the stiffness of adjacent members, and (3) increasing the stiffness of the joints. By enabling the use of uncertain or degrading members and their joints, a low-cost structure for the PTC can be achieved.

In the following description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure.

In addition, it is also to be understood that the singular forms “a,” “an,” and “the” used in the following description are intended to include the plural forms as well, unless the context clearly indicates otherwise. It is also to be understood that the term “and/or”,” as used herein, refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units, but do not preclude the presence or addition of one or more other features, integers, steps, operations, elements, components, units, and/or groups thereof.

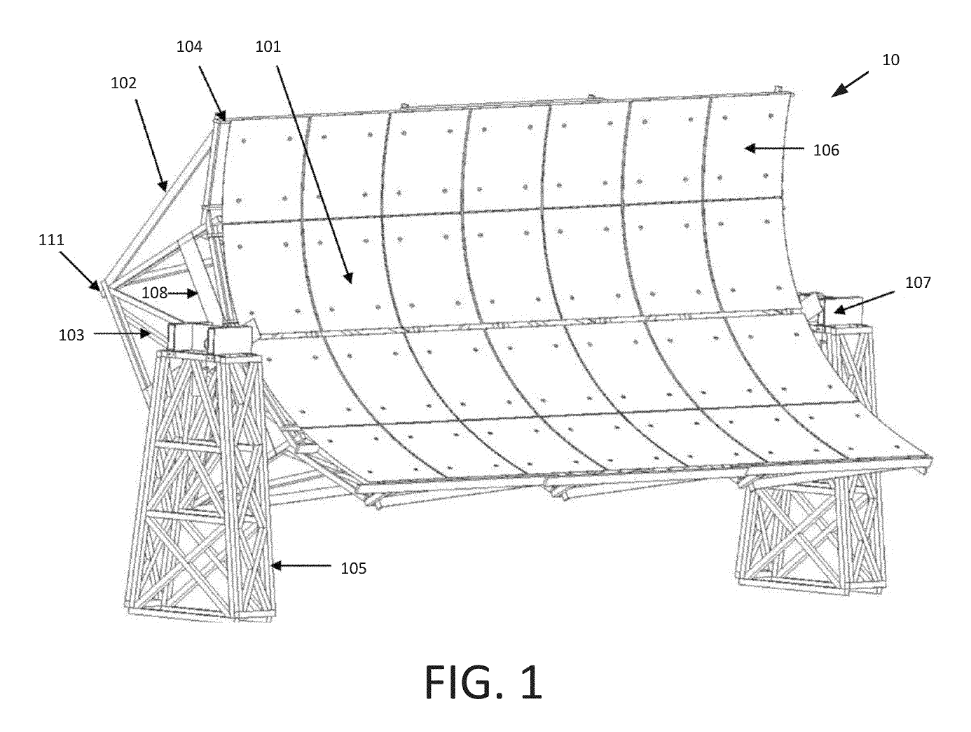

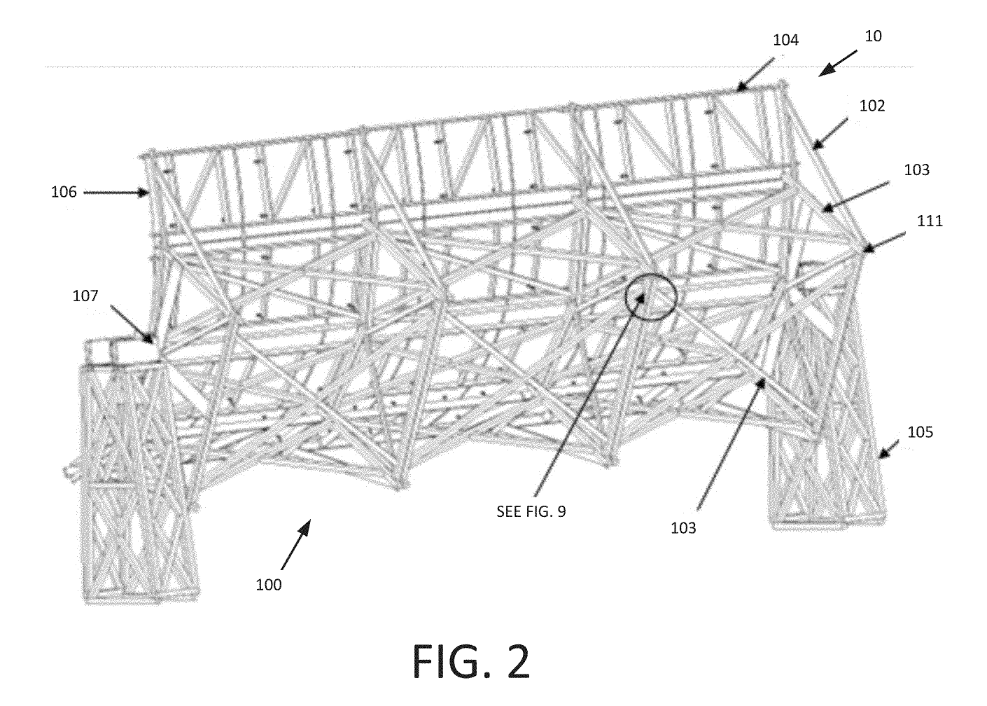

FIGS. 1 and 2 are isometric views of a parabolic trough solar collector 10 from the concave side and the convex side, respectively, according to one embodiment. The collector 10 includes a wooden spaceframe 100 that supports a parabolic trough reflector 101. The wooden spaceframe 100 may be rotatably mounted on pylons 105 via one or more actuators 107 and/or bearing assemblies so that the reflector 101 can be rotated for orientation toward the sun. By using a wooden frame rather than a conventional metal frame, the cost of the collector can be greatly reduced both in terms of materials and assembly labor costs.

The spaceframe 100 includes a plurality of wooden trusses 102 spaced longitudinally along the reflector 101 (the longitudinal extent of the reflector the dimension that is perpendicular to the parabolic curvature of the reflector). Each truss 102 extends across the width of the reflector 101, perpendicularly to the longitudinal extent of the reflector 101. The trusses 102 are configured to resist splaying of the reflector 101, which may be induced by wind forces. Collector end plates 108 may be attached to the end trusses. The collector end plates 108 can be used to mount the spaceframe 100 to the pylons 105 and for torque coupling to drive actuators or neighboring collector elements in an array. A wooden reflector support structure 104 is mounted on an upper side of the trusses 102 for providing the mounting points for the reflector 101. Wooden torsion-resisting structures 103 extend from one truss to the next to stiffen the spaceframe assembly and to resist torque induced by wind forces.

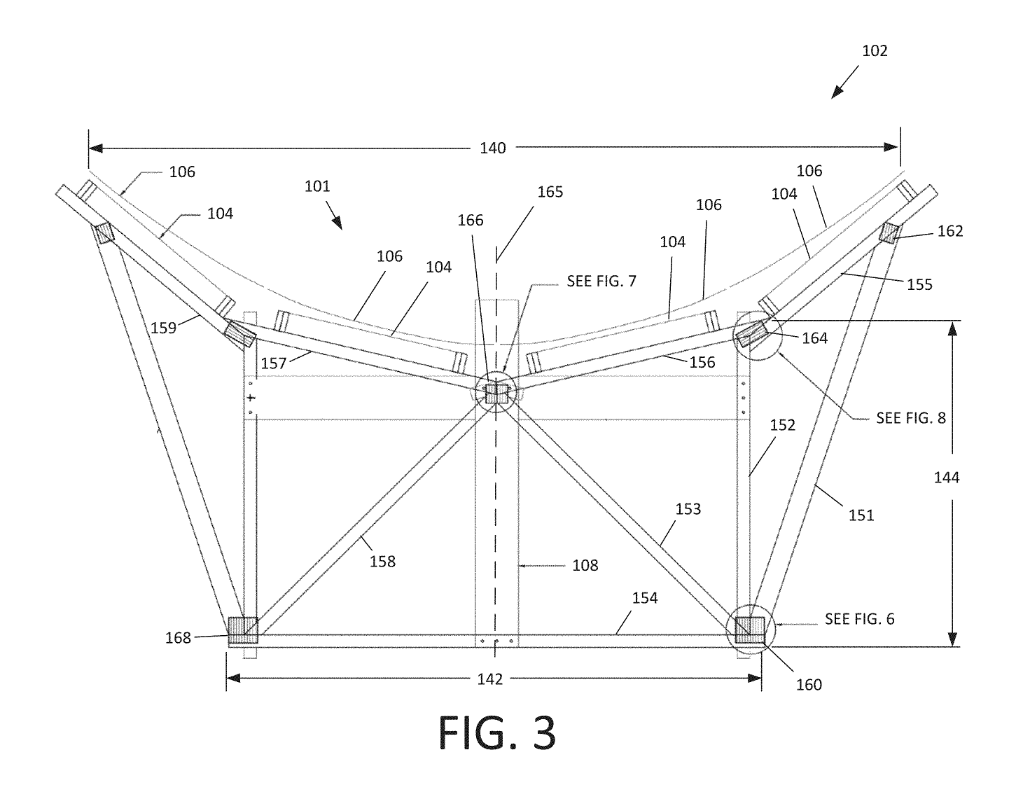

FIG. 3 illustrates a truss 102, according to one embodiment. Truss 102 includes a plurality of wood members connected at a plurality of joints. A set of top members (e.g., 156, 157) of the truss 102 are arranged to provide a platform for the reflector support structure 104, which may be mounted atop these top members of the truss. A web of members (e.g., 151, 152, 153) is arranged beneath the top members to provide splay resisting stiffness to the truss.

The design of the truss 102 combines the use of reduced joint count per truss with specified stiffness requirements to provide an acceptably stiff overall behavior with low material cost. The truss 102 is configured so that the stiffness of each wood member (SWM) is no stiffer than two times the stiffness of the joint (SJ) to which each wood member connects. In other words, for a given wood member X and a joint Y that connects the wood member X to one or more other wood members, the following is satisfied:

SWMₓ≤2×SJ_{y}

Member stiffness is defined over a gauge length equal to the free length of the member.

According to some embodiments, the joint stiffness of each joint (SJ) is greater than a predetermined minimum stiffness value. For example, in some embodiments, the predetermined joint stiffness value is 10 kN/mm and the stiffness of joint Y satisfies the following:

SJ_{y}>10 kN/mm

A collector having a truss structure designed with the above relationships between member and joint stiffness can achieve a high optical performance. For example, in some embodiments, a collector using a spaceframe with trusses configured according to the above relationships may have an intercept factor greater than 90% with a concentration ratio C that is greater than 50, while allowing for large joint deformations. The intercept factor is defined as the fraction of reflected light that intercepts the linear receiver disposed at the focal line. The concentration ratio is the ratio of mirror aperture width to receiver diameter. In some embodiments, allowable joint deformations can be about 1000 microns.

The top members (e.g., 155, 156, 157, 159) of the truss 102 are arranged to provide a platform that generally follows the parabolic curvature of the reflector 101. As such, the top members may join one another at an angle. A greater number of top members can be used to more closely follow the curvature of the reflector. The top members may each be the same length or may be different lengths. In some embodiments, including the embodiment illustrated in FIG. 3, four top members are used. Two inner top members (156, 157) extend outwardly from a center joint 166 located beneath the center of the reflector 101. Each of two outer top members (155, 159) extends outwardly from respective joints joining the outer top members with the inner top members. The outer top members (155, 159) extend toward the periphery of the reflector 101. The outer top members may stop short of the outer periphery of the reflector, may align with the outer periphery of the reflector, or may extend past the outer periphery of the reflector.

Wood members extend downwardly from joints with the top members forming a web that connects to a base 161 of the truss (the portion of the truss that is opposite the reflector). In some embodiments, two web members (153, 158) extend diagonally downward and outward from the center1 joint 166 to base joints (160, 168) located symmetrically on either side of the mid-plane 165 that bisects the reflector. Members (e.g., 151, 152) extend between each top joint (e.g., 162, 164) to the base joints (160, 168).

In some embodiments, the base includes two base joints 160 and 168 arranged symmetrically on either side of the mid-plane 165. Four wood members may join at each of the base joints. A first member 151 may extend from a first base joint 160 to a first top joint 162 that is adjacent to and beneath a periphery of the reflector 101. A second member 152 may extend from the first base joint 160 to a second top joint 164 that is adjacent to the reflector 101 at a location that is closer to the center of the reflector 101 than the first top joint 162. The second top joint 164 may join two top members (155, 156) and the second member 152 that extends from the first base joint 160. In some embodiments, the second member 152 is parallel to the mid-plane 165 bisecting the collector, and in other embodiments, the second member 152 is non-parallel with the mid-plane 165. A third member 153 may extend diagonally from the first base joint 160 to the center joint 166 that may be located at the mid-plane 165 beneath the center of the reflector 101. A fourth member (base member 154) may extend perpendicularly across the mid-plane 165 from the first base joint 160 to the second base joint 168 located on the opposite side of the base of the truss 102.

The wood members and joints may be configured to meet the stiffness design requirements discussed above. As such, the first member 151 may be configured so that its stiffness is less than or equal to twice the stiffness of the first base joint 160 at its first end and less than or equal to twice the stiffness of the first top joint 162 at its second end. Similarly, the second member 152 may be configured so that its stiffness is less than or equal to twice the stiffness of the first base joint 160 at its first end and less than or equal to twice the stiffness of the second top joint 164 at its second end. The third member 153 may be configured so that its stiffness is less than or equal to twice the stiffness of the first base joint 160 at its first end and less than or equal to twice the stiffness of the center joint 166 at its second end. The base member 154 may be configured so that its stiffness is less than or equal to twice the stiffness of the first base joint 160 at its first end and less than or equal to twice the stiffness of the second base joint 168 at its second end.

The top members may also meet the design requirements discussed above. As such, the outer top member 155 that joins with the first member 151 at the first top joint 162 and extends inwardly to the second top joint 164 may be configured so that its stiffness is less than or equal to twice the stiffness of each of the first and second top joints. The stiffness of the inner top member 156, which connects to the outer top member 155 at the second top joint 164 and extends inwardly to the center joint 166, may be configured so that its stiffness is less than or equal to twice the stiffness of each of the second top joint and center joint.

Trusses 102 that are located at the ends of the spaceframe 100 may include one or more connector end plates 108 for attaching the spaceframe to a pylon 105, for example, via bearings and/or actuators, or to an adjacent collector. The connector end plates 108 may be connected to one or more wood members via any suitable means, such as using screws, nails, bolts, ties, straps, etc. In some embodiments, the connector end plates 108 are wood and in other embodiments, the connector end plates are metal. Trusses may be pre-fabricated, which makes on-site assembly faster and lower cost.

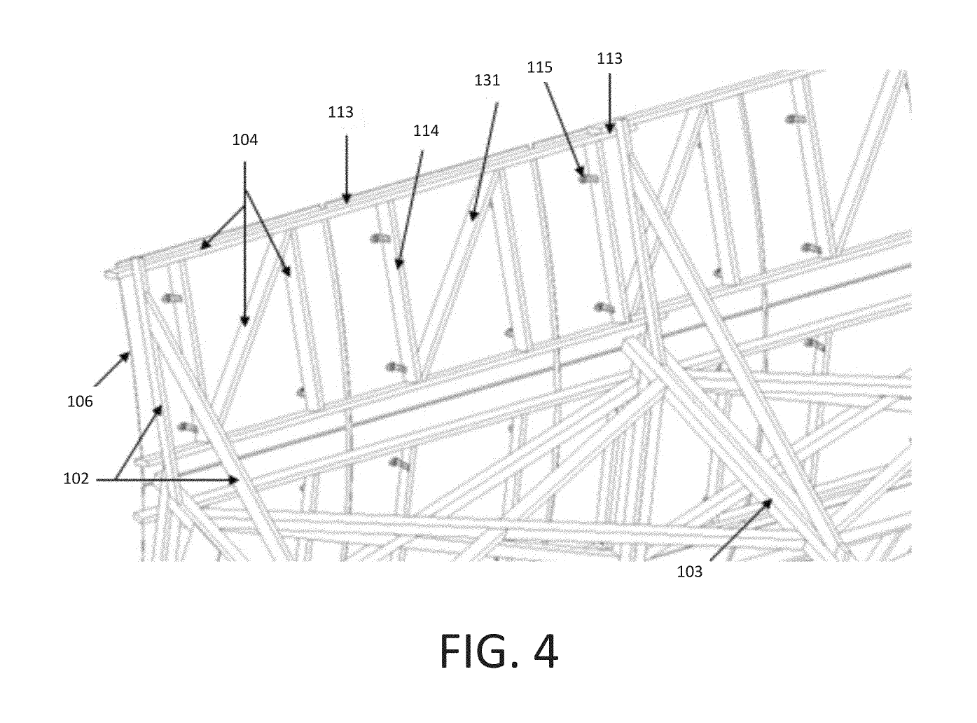

FIG. 4 illustrates a portion of the spaceframe 100 from the convex side of the reflector 101 showing the reflector support structure 104, according to one embodiment. The reflector support structure 104 may include a plurality of wood purlins 113 that extend from one truss 102 to the next and a plurality of wood rafters 114 that are parallel to the trusses. The reflector may be mounting to the purlins, to the rafters, or to both. Rafters 114 may serve two functions: (1) they may provide mounting locations for reflector mounting brackets 115, and (2) the rafters 114 may make the reflector support structure 104 stiffer against bending. In some embodiments, the rafters 114 may increase the stiffness of the reflector support structure by at least four times. Additional stiffness may be achieved with bracing members 131. This additional stiffness may be required to prevent large rotation and translation of the reflected light. In some embodiments, the reflector support structure 104 is comprised of a plurality of prefabricated sections with each section mounted as a whole to tops of the trusses. In some embodiments, a prefabricated section is configured to span from one truss to the next and to mount to a particular portion of the truss—such as a section for each top member.

In some embodiments, the reflector 101 is made of a plurality of reflector panels 106 and the support structure 104 may be configured based on the size of the reflector panels 106. For example, purlins 113 may be spaced such that at least one purlin underlies each reflector panel 106. Similarly, rafters 114 may be spaced such that at least one rafter 114 underlies each reflector panel 106. In some embodiments, purlins and rafters may be spaced such that at least two purlins 113 and at least two rafters 114 underlie each reflector panel 106.

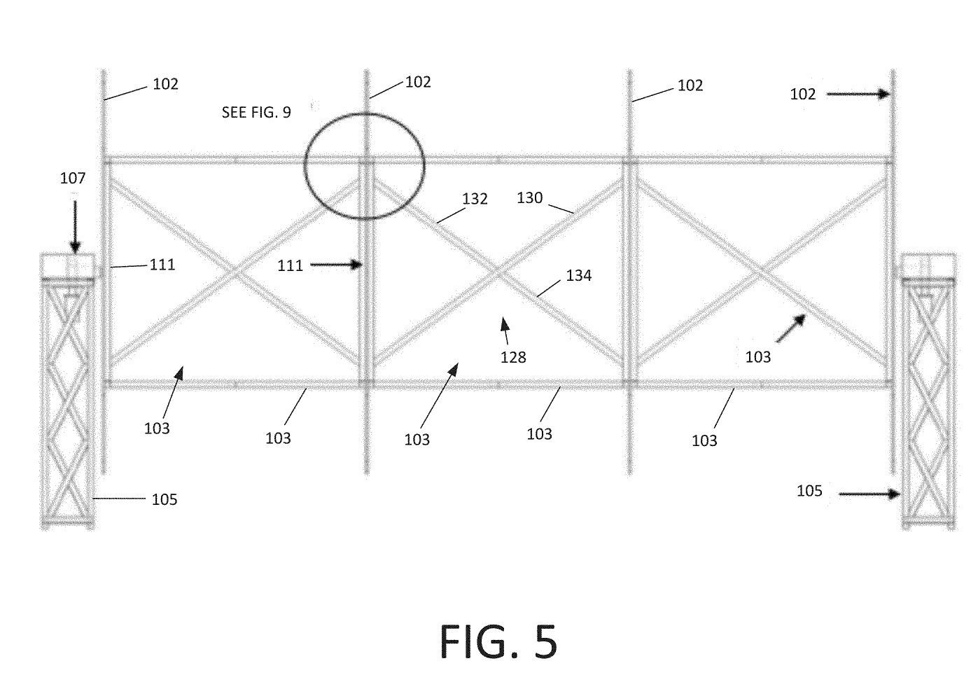

FIG. 5 is a posterior view of the spaceframe 100 (i.e. looking directly at the bases of the trusses), illustrating the spacing of the trusses 102, according to one embodiment. Between adjacent trusses, a torsion-resisting structure 103 may be provided. The torsion-resisting structure 103 is configured to resist torsion of the collector about its longitudinal extent, which may be induced via wind forces. The torsion-resisting structure 103 may include wood members that form a diagonal cross 128. In some embodiments, a continuous member 130 extends from a corner of the base of one truss to the opposite corner of base of the adjacent truss. Two members 132, 134 form a two-piece crossing member, with each member 132, 134 extending from respective corners of the bases of the adjacent trusses to the midpoint of the continuous member 130. In some embodiments, wood beams 111 are provided at the ends of the diagonal cross structure, with the ends of the diagonal cross structure being affixed to the beams 111. The beams 111 may be attached to one or more members of the trusses, for example, via bolts or screws, to affix the torsion-resisting structure to the trusses.

Multiple torsion-resisting structures 103 can bridge adjacent trusses 102 to increase stiffness of the spaceframe 100. For example, a torsion-resisting structure can extend from each member of the truss to the corresponding member of the adjacent truss. In some embodiments, five torsion-resisting structures extend between adjacent trusses. Referring to FIG. 3, a torsion-resisting structure may extend between members 152 of adjacent trusses, between base members 154 of adjacent trusses, and between both inner top members 156 and 157 of adjacent trusses. In some embodiments, torsion-resisting structures are pre-fabricated and assembled to adjacent trusses on-site.

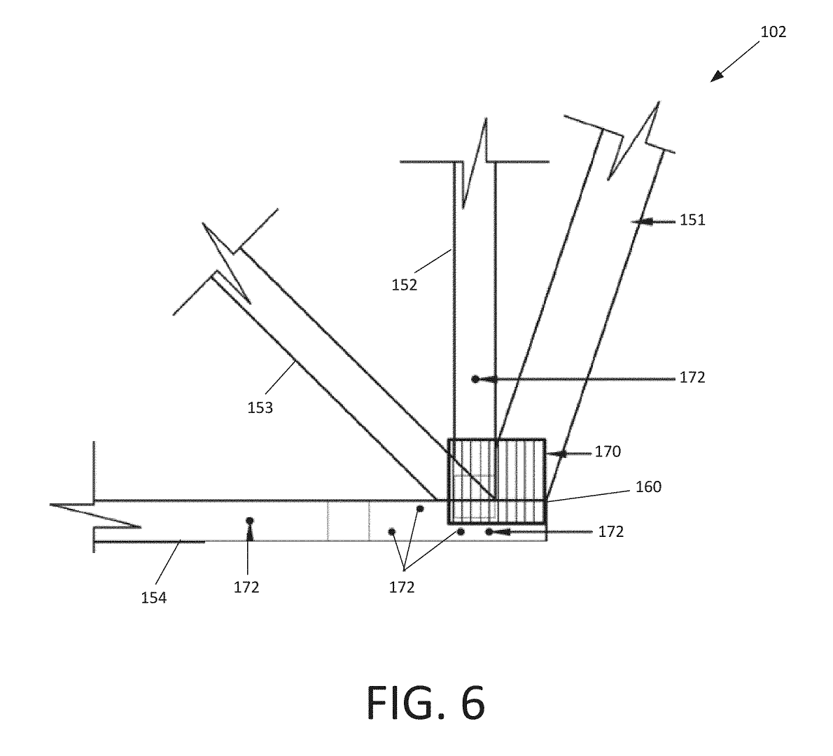

FIG. 6 is an enlarged view of the first base joint 160 of truss 102 showing the manner of joining the wood members to one another, according to an embodiment. Members 151, 152, 153, and 154 meet at the first base joint 160 and are joined together using a connector plate 170. The ends of the members may be cut such that their ends align flush with the adjacent members. The connector plate 170 may be configured to provide the stiffness required to meet the design parameters described above. In some embodiments, a connector plate 170 is provided on both sides of the truss. In some embodiments, additional means are used to further stiffen the joint, such as screws, bolts, nails, wood glue, ties or any other suitable means.

Screws and/or bolts 172 may be used to attach the torsion-resisting structure(s) 103 near the first base joint 160. In the embodiment shown in FIG. 6, a torsion-resisting structure is provided along the base member 154 and along the second member 152. The bolts and/or screws 172 may attach the beams 111 of the respective torsion-resisting structure to the corresponding members of the truss 102.

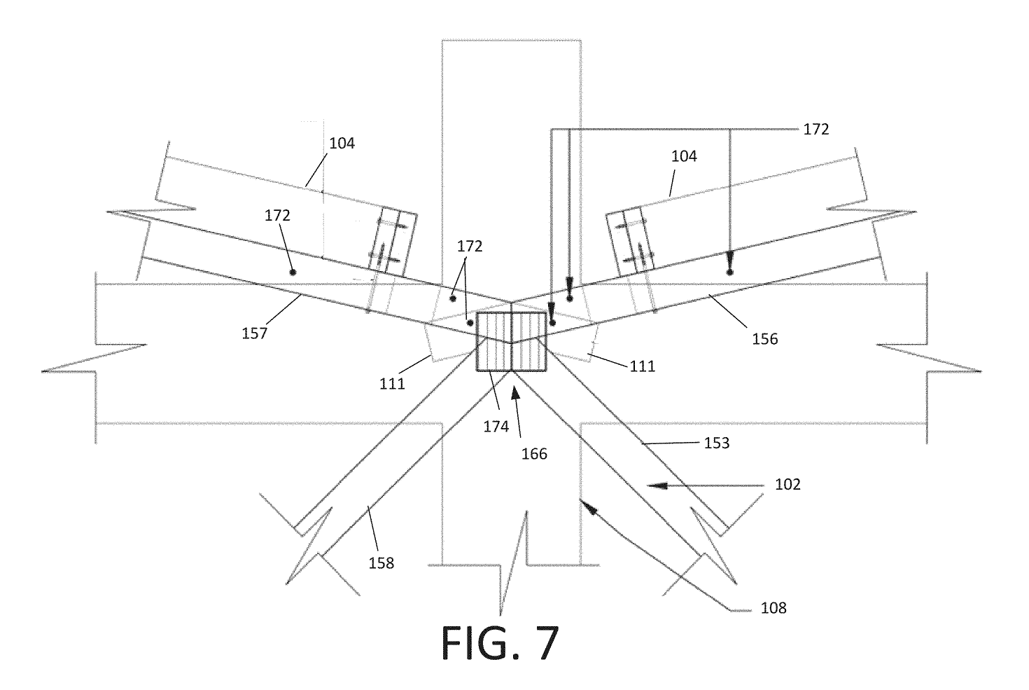

FIG. 7 is an enlarged view of center joint 166 of truss 102, according to one embodiment. Center joint 166 is the connection of two inner top members (156 and 157) with two members (153 and 158) that extend from respective base joints. A connector plate 174 may be used to connect the four members together. Additional fasteners, such as screws, bolts, nails, etc., may be used, for example, to increase the stiffness of the joint. Screws and/or bolts 172 may be used to attach torsion-resisting structure(s) 103. For example, beams 111 of a torsion-resisting structure 103 may be attached to both of the inner top members 156, 157. Respective portions of reflector support structure 104 may sit atop the top members 156, 157 and may be attached using any suitable means, including nail plates, screws, nails, bolts, etc. Also shown in FIG. 7 is the collector end plate 108, which may be attached to the trusses that are at the ends of the spaceframe 100.

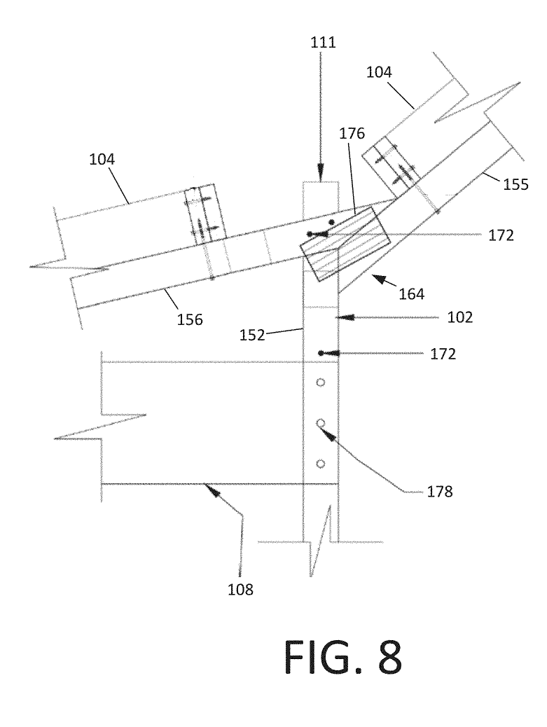

FIG. 8 is an enlarged view of the second top joint 164 of truss 102, according to one embodiment. The second top joint 164 is the connection point for: member 152 (which extends from first base joint 160), the inner top member 156 (which extends from the center joint 166), and the outer top member 155 (which extends to the periphery of the reflector 101). A connector plate 176 may be used to connect the three joining members together. Additional fasteners, such as screws, bolts, nails, etc., may be used, for example, to increase the stiffness of the joint. Screws and/or bolts 172 may be used to attach torsion-resisting structure(s) 103. For example, beams 111 of torsion-resisting structures 103 may be attached to the inner top member 156 and to the member 152 that extends from the first base joint 160. Respective portions of reflector support structure 104 may be attached to the top members 156 and 155 using any suitable means, including nail plates, screws, nails, bolts, etc.

For trusses with a collector end plate 108, the collector end plate may be attached to one or more members, such as member 152, using any suitable means, including any combination of bolts, nails, screws, brackets, ties, etc. In the embodiment of FIG. 8, three bolts 178 attach an end of the collector end plate 108 to member 152.

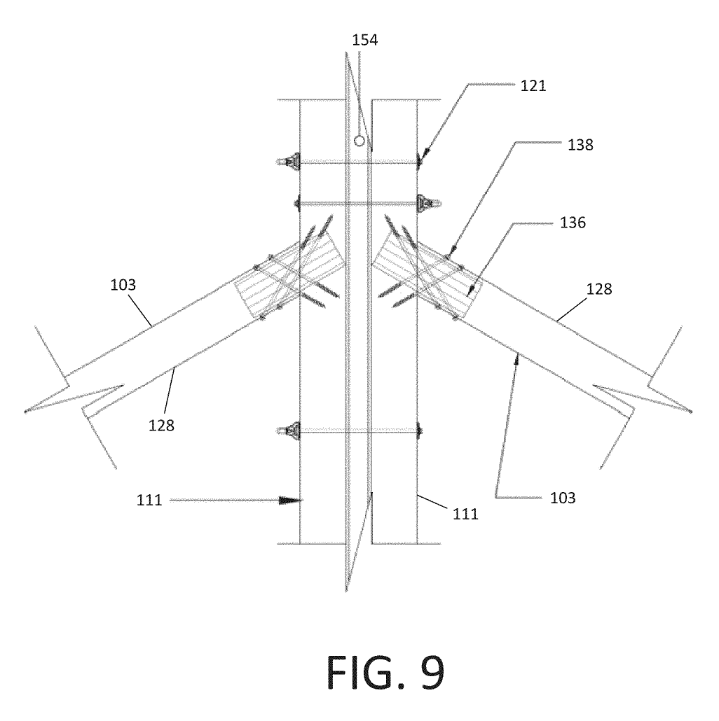

FIG. 9 is an enlarged view of a portion of the spaceframe 100 showing a truss 102 sandwiched between two torsion-resisting structures 103, according to one embodiment. The plane of the view is perpendicular to the plane of the truss 102. The portion of the truss 102 that is shown is the base member 154. The end beams 111 of the torsion-resisting structures 103 extend along the sides of the base member 154. These end beams 111 may be joined to the base member 154 using any suitable means, including screw bolt fasteners 121. These screw bolts 121 are long enough to simultaneously join the two torsion-resisting structures 103 and the base member 154 of the truss in between to provide high strength and stiffness. The diagonal cross members 128 may be joined to the end beams 111 by connector plates 136. In some embodiments, wood lag screws 138 may also be provided to attach the cross members 128 to provide additional stiffness and strength.

Connector plates used in joints of the spaceframe 100, such as the connector plates 170, 174, 176 of the truss 102 are configured to provide the strength and stiffness required for the particular application and the particular location within the spaceframe. Connector plates may be truss connector plates (also commonly referred to as a nail plates), which provide high stiffness at low cost. Truss connector plates are commonly used in truss construction but not conventionally used in outdoor applications. The size, material, and gauge of the connector plate may be selected based on the strength and stiffness requirements of the particular truss 102 and the particular joint of the truss. In some embodiments, truss connector plates with added screws are used for one or more of the joints of a truss. The added screws may prevent plate “back-out” that may otherwise occur due to moisture cycles. Painting, according to some embodiments, also reduces or eliminates nail plate backout, as has been discovered through accelerated weathering testing.

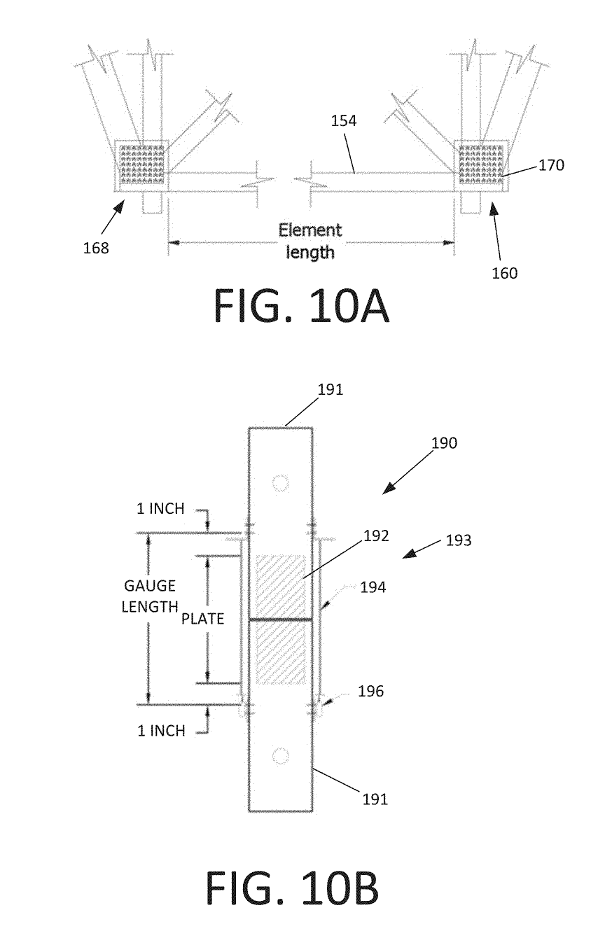

FIGS. 10A and 10B illustrate how the stiffnesses of the joints and members are defined and measured, according to some embodiments. As shown in FIG. 10A, the joint may be defined as the area of the connector plate (such as connector plate 170) plus a one inch offset on all sides. The length of a member (such as base member 154) may be defined as the distance from the one-inch offset of a first joint to the one-inch offset of the second joint.

The stiffness of a joint is defined as the ratio of force to local deformation of the joint. FIG. 10B illustrates a test set-up 190 for determining the stiffness of a joint. The ends of two members 191 are joined by a connector plate 192. A deformation gauge 193 is used to measure the deformation over a gauge length defined as the length of the connector plate 192 plus a one-inch (25 mm) offset on each end. The deformation gauge 193 includes a gauge rod 194 and a position transducer 196. During a stiffness measurement test, the force (for example, 2000 lb) that is estimated to be the likely change in service axial force due to wind for the particular collector application is applied, and the deformation of the joint is recorded using the deformation gauge 193.

An exemplary test set-up may include a manual pull tester rated for 8,900 N in tension (Analog Fastener Tester, model SP1-2K-RS, Force-Test Inc., Clearwater, Fla.). The pull tester is fixed to a reinforced table, and a load cell is mounted in line with clevis clamps and the test specimen. Two opposing potentiometer linear displacement sensors may be used to account for rotation artifacts. Displacement and load are sampled at 2 Hz. A displacement accuracy of ±2.5 μm and a load accuracy of ±0.05 kN, which are more stringent that that required by conventional ASTM testing standards, may be maintained. Five half-cycles with amplitude of 9 kN may be applied during the test.

Parabolic trough solar collector embodiments may be configured to meet the requirements of a particular application. A higher energy application may require a reflector with a larger aperture and/or length than a lower energy application and a spaceframe may be configured and sized accordingly. As such, the particular configurations illustrated in the figures and described above are merely exemplary. One of skill in the art would readily understand how to apply the spaceframe design principles described above to a particular application. For example, smaller collectors may have spaceframes with fewer members and/or smaller members (in width, thickness, and/or length) and/or different geometries. One of skill in the art would readily understand how to select the sizes of members and geometries of trusses to meet the strength and stiffness requirements of a given application and to satisfy the stiffness relationships between truss members and truss joints described above.

In some embodiments, a truss as illustrated in FIG. 3 may be sized as a function of the reflector that it supports. For example, a width 142 of the base of the truss from the outermost extents of the two base joints may be greater than or equal to one-half of the aperture width 140 of the reflector. A height 144 of the truss-defined as the distance from the bottom of the base member 154 to the top of top joint 164—may be greater than or equal to one-quarter the aperture width.

In some embodiments, the stiffness of one or more joints of a truss is at least 5 kN/mm, at least 10 kN/mm, at least 20 kN/mm, at least 40 kN/mm, at least 60 kN/mm, at least 80 kN/mm, at least 90 kN/mm, at least 100 kN/mm, or at least 110 kN/mm. In some embodiments, the stiffness of one or more joints of a truss is at most 120 kN/mm, at most 100 kN/mm, at most 90 kN/mm, at most 80 kN/mm, at most 70 kN/mm, at most 50 kN/mm, at most 25 kN/mm, at most 15 kN/mm, or at most 10 kN/mm.

In some embodiments, the stiffness of one or more wood members of a truss is at least 2 kN/mm, at least 5 kN/mm, at least 10 kN/mm, at least 15 kN/mm, at least 20 kN/mm, at least 25 kN/mm, or at least 30 kN/mm. In some embodiments, the stiffness of one or more joints of a truss is at most 50 kN/mm, at most 30 kN/mm, at most 25 kN/mm, at most 20 kN/mm, at most 15 kN/mm, or at most 10 kN/mm.

According to an exemplary embodiment, a collector is configured with a reflector having a 6 m aperture width (140 in FIG. 3) and a 12 m length. The spaceframe for the collector includes four trusses configured as shown in FIG. 3. Member 151 (and the corresponding member on the opposite side) is a 2×6 (nominal) with a length of about 10 feet, one and nine-sixteenths inches. The other nine members are 2×4s (nominal). Outer top members 155 and 159 each have a length of about five feet, 8 and one-quarter inches. Members 156 and 157 each have a length of about six feet, four and thirteen-sixteenths inches. Members 153 and 58 each have a length of about eight feet, one-half inch. Members 152 and the corresponding member on the opposite side each have a length of about six feet, eleven and a half inches. Suitable truss connector plates are Mitek MT20 truss connector plates. The connector plates for joint 162 (and the corresponding joint on the other side) are 4×5 inch plates, the connector plates for joint 64 (and the corresponding joint on the other side) are 4×8 inch plates, the connector plate for joints 160 and 168 are 8×7 inch plates, and the connector plates for joint 166 are 6×6 inch plates. Each joint has two plates—one on each side of the truss.

In this exemplary embodiment, outer top member 155 extends past top joint 164 to prevent splitting due to fastener insertion at the end of the member. The truss members are joined using truss connector plates. Five torsion-resisting structures 103 extend between adjacent trusses 102 at member 152 (and the corresponding member on the opposite side of the truss), base member 154, and inner top members 156 and 157. The end beams and diagonal cross members are 4×4s. The torsion-resisting structures 103 are affixed to the trusses 102 using screw bolts according to the configuration shown in FIG. 9. With this configuration, the torsional stiffness of the spaceframe is 2.5 kNm/mrad for an intercept factor of at least 90% with a concentration ratio of at least 50 under 56 km/hr wind load.

Spaceframes may be made from any suitable wood product. For example, Douglas Fir grade #2, kiln-dried lumber may be used. Other grades, such as Select Structural, #1, or #3, and other species, such as Cedar, Redwood, and Hem-Fir, may be used. In some embodiments, one or more members of the spaceframe are made of engineered wood like plywood or oriented strand board. Wood members may be standard size lumber, such as nominal cross-sectional sizes of 2×4, 2×6, 2×8, 2×10, 2×12, 4×4, 4×6, 4×8, 6×6, and 8×8. Wood members may be treated with preservatives or untreated. Spaceframes may be painted to protect from weathering and to protect nail plate joints from backout. In some embodiments, a wood member may be formed from multiple wood boards. For example, a member may be formed from two 2×12s attached together using nails, screws, glue, or any other suitable means to form a nominal 4×12 member.

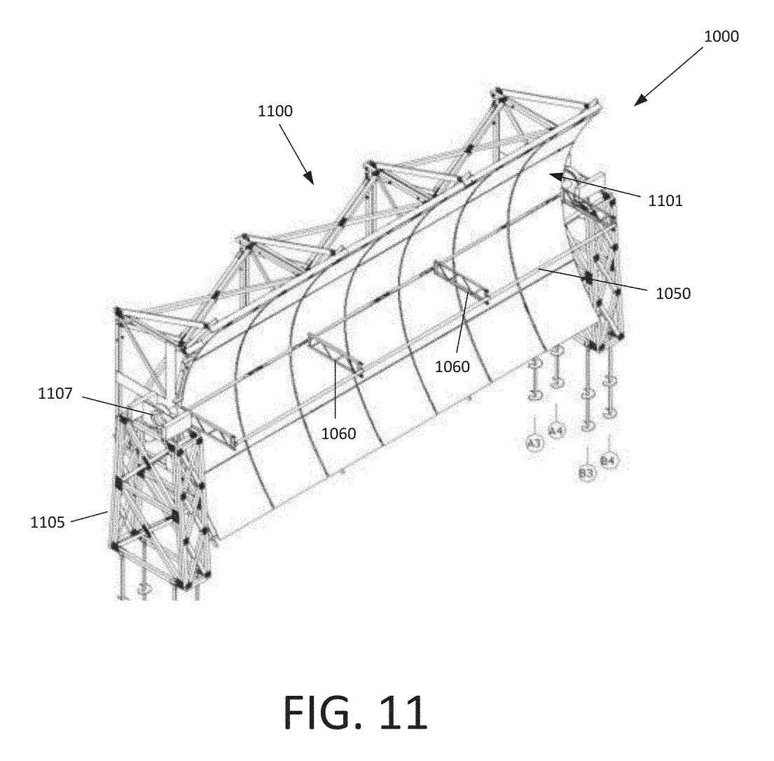

FIG. 11 illustrates a parabolic trough collector 1000, according to one embodiment. The collector 1000 includes a spaceframe 1100 supporting a parabolic trough reflector 1101. A receiver 1050 is located at the focal line of the reflector 1101 and is support by a plurality of risers 1060 that extend from the spaceframe 1100. As the spaceframe is rotated by the actuator 1107 mounted on the pylon 1105, the reflector 1101 and receiver 1050 rotate together for aligning with the sun.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A parabolic trough solar collector comprising:
a parabolic trough reflector extending in a longitudinal direction; and
a frame supporting the reflector, the frame comprising at least one truss extending perpendicular to the longitudinal direction, the at least one truss comprising a plurality of wooden members connected at a plurality of joints, wherein:
a first wooden member has a stiffness SWM1,
a second wooden member has a stiffness SWM2, and
a first joint that connects the first wooden member and the second wooden member together has a stiffness SJ1, and wherein:
SWM1≤2×SJ1, and
SWM2≤2×SJ1.

2. The collector of claim 1, wherein a third wooden member and a fourth wooden member are connected at the first joint, the third wooden member has a stiffness SWM3, the fourth wooden member has a stiffness SWM4, and wherein:
SWM3≤2×SJ1, and
SWM4≤2×SJ1.

3. The collector of claim 2, wherein the first wooden member extends from the first joint to a second joint that is adjacent to an outer portion of the reflector and the second joint has a stiffness SJ2, and wherein:
SWM1≤2×SJ2.

4. The collector of claim 3, wherein a fifth wooden member extends along the reflector to a third joint, the fifth wooden member has a stiffness SWM5, and the third joint has a stiffness SJ3, and wherein:
SWM5≤2×SJ3.

5. The collector of claim 4, wherein the second wooden member extends from the third joint to the first joint, and wherein:
SWM2≤2×SJ3.

6. The collector of claim 2, wherein the reflector has an aperture width AW and a base of the at least one truss has a width WB, and wherein:
WB≥½×AW.

7. The collector of claim 6, wherein the at least one truss has a height TH that extends perpendicularly to the base from a bottom of the base to a top of a joint that is adjacent to the reflector, and wherein:
TH≥¼×AW.

8. The collector of claim 1, wherein the third wooden member extends to a joint that underlies a midpoint of the reflector.

9. The collector of claim 1, wherein the first joint comprises at least one connector plate that joins ends of the first and second wooden members together.

10. The collector of claim 1, wherein the truss comprises at least eleven wooden members and at least seven joints.

11. The collector of claim 1, wherein the truss comprises at most eleven wooden members and at most seven joints.

12. The collector of claim 1, wherein a first truss is connected to a second truss by a torque-resisting wooden structure, and the torque-resisting wooden structure connects a lower joint of the first truss to an upper joint of the second truss.

13. The collector of claim 12, wherein the torque-resisting wooden structure connects an upper joint of the first truss to a lower joint of the second truss.

14. The collector of claim 1, wherein the reflector comprises at least one reflector panel and the at least one reflector panel is mounted to at least one rafter that is parallel to the at least one truss.

15. The collector of claim 14, wherein the rafter is mounted on a purlin that extends between two trusses.

16. The collector of claim 1, wherein the frame is rotatably mounted to support pylons so that the reflector can be rotated based on a position of the sun.

17. The collector of claim 1, wherein:
SJ1≥10 kN/mm.

18. The collector of claim 1, wherein an intercept factor of the collector is at least 90% with a concentration ratio of at least 50.
